(19) United States
(12) Patent Application Publication
(10) Pub. No.: US 2012/0254320 A1
(43) Pub. Date: Oct. 4, 2012

(54) DISTRIBUTING COLLECTED INFORMATION TO DATA CONSUMERS BASED ON GLOBAL USER CONSENT INFORMATION

(75) Inventors: Bryan J. Dove, Seattle, WA (US); Sean P. Nolan, Bellevue, WA (US); Johnson T. Apacible, Mercer Island, WA (US); Michael J. Bortnick, Oswego, IL (US)

(73) Assignee: Microsoft Corporation, Redmond, WA (US)

(21) Appl. No.: 13/079,019

(22) Filed: Apr. 4, 2011

(51) Int. Cl. G06F 15/16

(52) U.S. Cl. 709/206; 709/204

(57) ABSTRACT

An information management system is described herein which maintains collected information that pertains to users, received from one or more data sources. The information management system also maintains a store of consent information. The consent information describes, for each user, at least one permission rule (established by the user) which enables at least one data consumer to receive at least part of the collected information for that user. Upon the occurrence of a triggering event, an information distribution module operates by distributing identified part(s) of the collected information to appropriate data consumer(s), as governed by the consent information. In this manner of operation, the consent information functions as global metadata which, from a centralized platform, governs the dissemination of the collected information to any data consumer in an application-agnostic manner.

### BACKGROUND

Mechanisms are available that enable a user to share personal information that is native to one network-accessible service with one or more data consumers. A data consumer refers to any endpoint (such as another service) that receives and uses the personal information for any reason. For example, suppose that a user maintains personal information at plural social networking services. In certain cases, a user can set up two or more social networking services to make their information available to any data consumer. To do so, the user separately accesses and configures the social networking services, e.g., by instructing each social networking service to make its personal information available to the data consumer. In general, the sharing of information in the above-described environment is managed in a fractured and local manner. Further, each service uses a different identifier (such as a login ID) to refer to a particular user.

Healthcare-related services operate in a similar manner. Consider the case of a healthcare-related service that allows a user to maintain a repository of personal healthcare records. Different applications may work in conjunction with this type of healthcare-related service. Some of these applications may allow a user to share his or her personal healthcare records with healthcare professionals. But, again, this manner of sharing is fractured and application-specific. As such, if the user wishes to enable two applications to share personal information with health professionals, the user is expected to separately configure both applications in an appropriate manner.

While useful, the above-described approach to sharing information is not without its shortcomings, to be set forth in the Detailed Discussion below.

### SUMMARY

An information management system is described herein which maintains collected information that pertains to users, received from one or more data sources. The information management system also maintains a store of consent information. The consent information describes, for each user, at least one permission rule (established by the user) which enables at least one data consumer to access at least part of the collected information. Upon the occurrence of a triggering event, an information distribution module operates by distributing identified part(s) of the collected information to appropriate data consumer(s), as governed by the consent information. In this manner of operation, the consent information functions as global metadata which, from a centralized platform, governs the dissemination of the collected information to any data consumer in application-agnostic manner.

According to one illustrative implementation, the collected information corresponds to healthcare-related information. An illustrative data consumer may correspond to a doctor, clinic, hospital, etc.

According to another illustrative aspect, the information management system includes an administrative module which establishes a master identifier for each user. That master identifier may be associated with one or more subordinate identifiers. Further, in some implementations, the master identifier may pertain to an identifier that has already been established by a service other than the information management system.

According to another illustrative aspect, the consent information defines one or more of: a nature of the collected information which a data consumer is entitled to access; a data source from which a data consumer is entitled to access the collected information; the identities of the data consumer(s) that are entitled to access the collected information; a temporal condition pertaining to when a data consumer is permitted to receive the collected information; an indication of whether one or more providers of respective services are permitted to send messages to a user; and an indication of whether one or more other users are permitted to send messages to the user, etc.

According to one illustrative case, the triggering event that invokes the distribution of information corresponds to a request, by a data consumer, to access at least part of the collected information. According to another illustrative case, the triggering event is a decision to push at least part of the collected information to the data consumer, independent of a request by the data consumer.

According to another illustrative aspect, the information management system can include searching functionality that allows inquiring entities to contact users without revealing sensitive information pertaining to the users to the inquiring entities. In one implementation, the search functionality operates by: receiving a search request from an inquiring entity to locate users who meet a specified search condition; performing a search within user-related information in response to the search request, to provide original search results that identify at least one candidate user; obfuscating sensitive information in the original search results that identifies said at least one candidate user, to provide obfuscated search results; and sending the obfuscated search results to the inquiring entity. The inquiring entity may analyze the obfuscated search results and identify at least one target user to send a message to (without gaining knowledge of the actual identities of the target user(s)). At this juncture, the searching functionality operates by receiving a request from the inquiring entity to send a message to the target user(s), and then sending a message to the target user(s).

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative information management service which allows users to share personal information with data consumers, as controlled by consent information.

FIG. 2 shows an illustrative data structure that can be used to express the consent information.

FIG. 3 is a conceptual diagram that shows the association of a master identifier with plural subordinate identifiers.

FIG. 4 shows searching functionality that can be used to send messages to users, without revealing the identities of the users to inquiring entities.

FIG. 5 shows one illustrative implementation of the information management system of FIG. 1.

FIG. 6 shows a procedure for establishing a master identifier for a user and adding that master identifier to a user information data store.

FIG. 7 shows a procedure for receiving information from a data source and adding that information to a collected information data store.

FIG. 8 shows a procedure for receiving consent information from a user and adding that information to a centralized consent information data store.

FIG. 9 shows a procedure which describes one manner of distributing personal information to a data consumer.

FIG. 10 shows a procedure that is a particular instantiation of the procedure of FIG. 9, for the case in which a data consumer expressly requests collected information.

FIG. 11 shows a procedure which describes one manner of performing a search to locate at least one target user, and then sending a message to the target user(s) without revealing the identity(ies) of the target user(s) to an inquiring entity.

FIG. 12 shows a procedure for providing a local instance of at least part of the services and/or collected information provided by the information management system.

FIG. 13 shows illustrative processing functionality that can be used to implement any aspect of the features shown in the foregoing drawings.

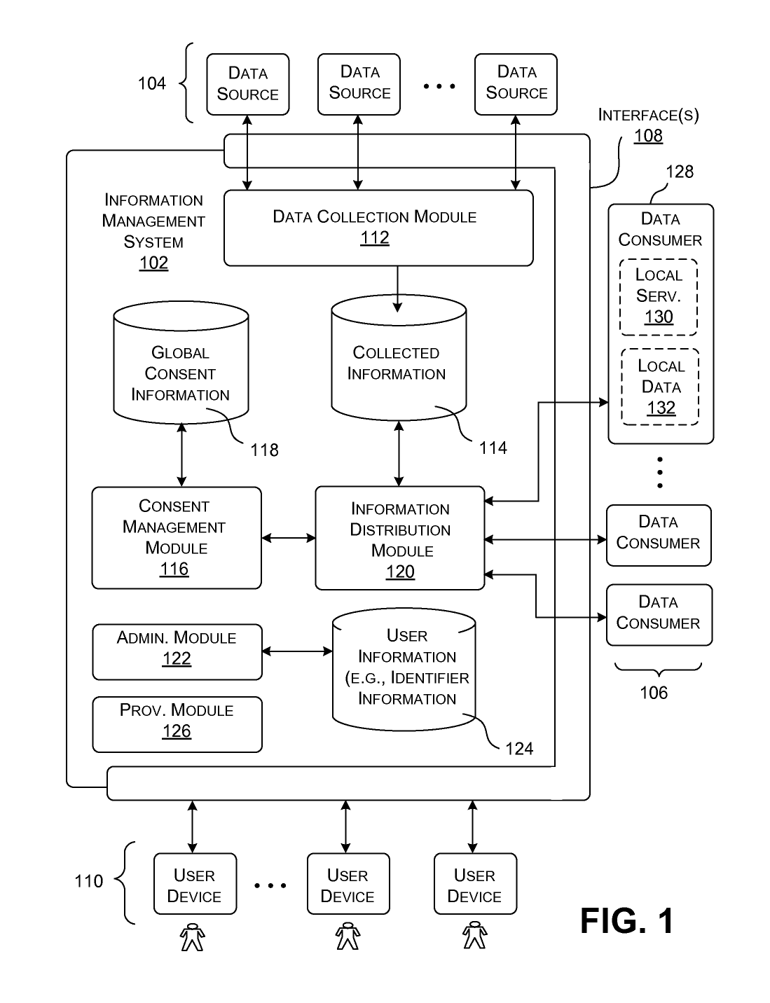

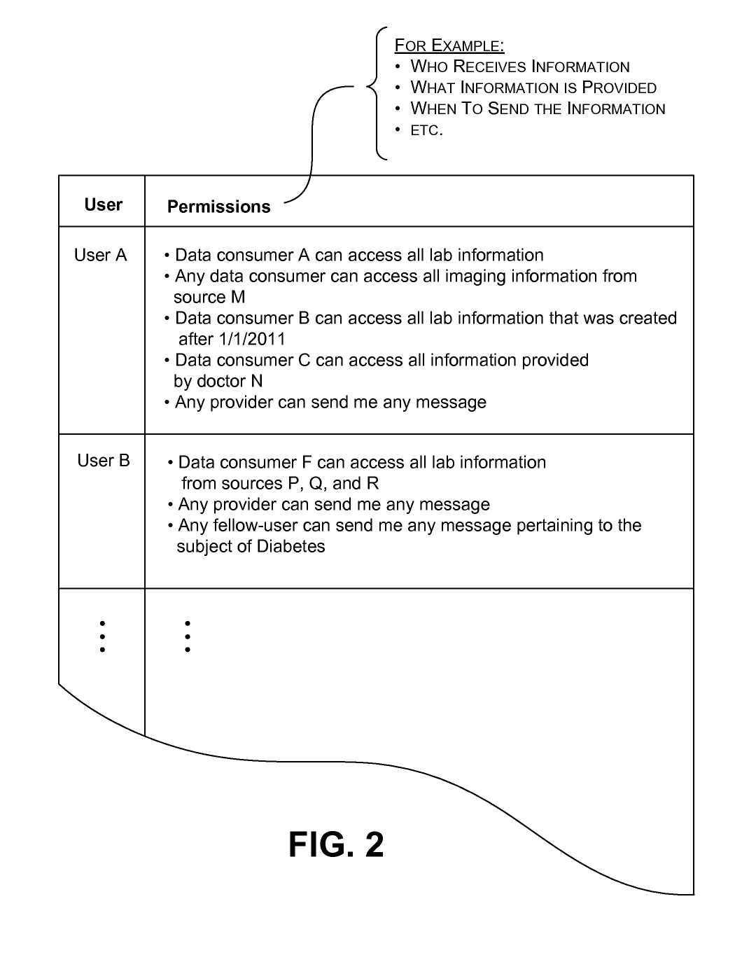

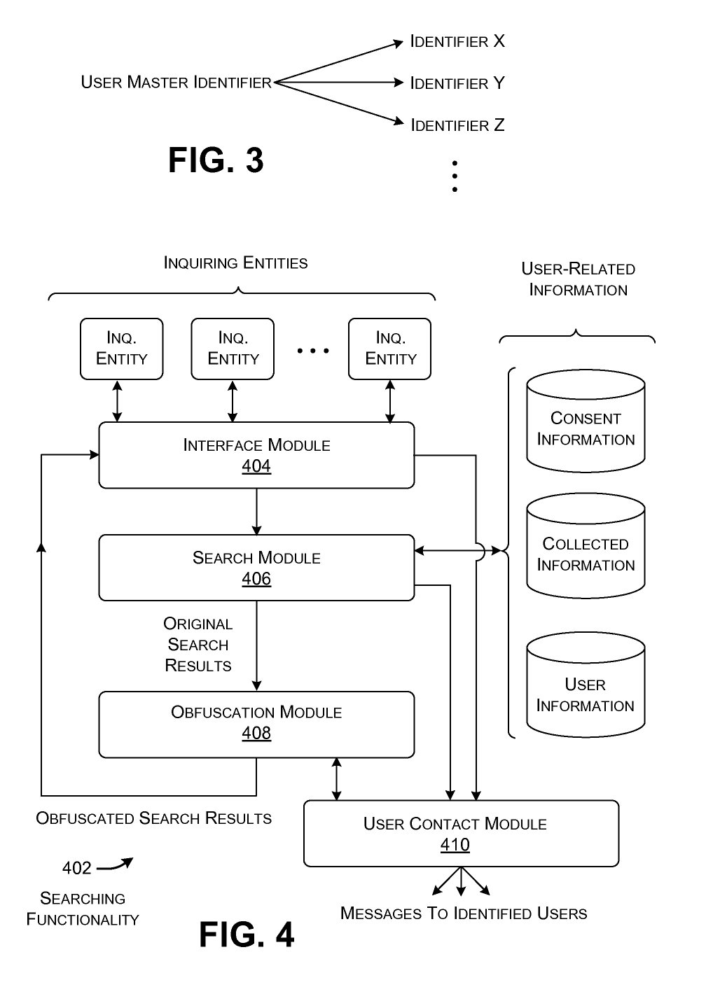

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative information management system for disseminating information to data consumers, as governed by global consent information. Section B describes illustrative methods which explain the operation of the information management system of Section A. Section C describes illustrative processing functionality that can be used to implement any aspect of the features described in Sections A and B.

As a preliminary matter, some of the figures describe concepts in the context of one or more structural components, variously referred to as functionality, modules, features, elements, etc. The various components shown in the figures can be implemented in any manner by any physical and tangible mechanisms (for instance, by software, hardware, firmware, etc., and/or any combination thereof). In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 13, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms (for instance, by software, hardware, firmware, etc., and/or any combination thereof).

As to terminology, the phrase “configured to” encompasses any way that any kind of physical and tangible functionality can be constructed to perform an identified operation. The functionality can be configured to perform an operation using, for instance, software, hardware, firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware, firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Systems

FIG. 1 shows an information management system 102 for collecting information from data sources 104 and disseminating the information to data consumers 106. The information management system 102 can be applied to any environment, and thus the information being collected and disseminated can pertain to any subject or combination of subjects. However, to facilitate explanation, the following description will be mainly framed in the representative context of the management of healthcare-related information. The healthcare-related information can pertain to any data that has a bearing on the medical treatment or general wellbeing of individuals, including, but not limited to, medical record information, lab information, imaging information, and so on.

In the healthcare-related environment, the data sources 104 can pertain to any entities which provide healthcare-related information pertaining to users. For example, the data sources 104 can represent information entered by any individual (e.g., doctors, nurses, administrative personnel, laboratory personnel, imaging specialists, etc.) in any environment (e.g., hospital settings, doctor office settings, clinic settings, laboratory settings, etc.). Or users may themselves enter the information. The data consumers 106 can pertain to any entities which make use of the healthcare-related information for any reason. For example, the data consumers 106 can include any individual (e.g., doctors, nurses, administrative personnel, laboratory personnel, imaging specialists, fellow-users, etc.) in any environment (e.g., hospital settings, doctor office settings, clinic settings, laboratory settings, etc.). Further, any data consumer may also function in the role of a data source, and vice versa. In some cases, a data consumer may be associated with a local data consumer system, such a computer system that serves a hospital.

The information management system 102 itself can include (or can be conceptualized as including) a number of modules that serve different functional roles. These modules can be provided at a single central site or can be distributed among plural sites at different respective locations. In one case, the information management system 102 is administered by a single entity. In another case, the information management system 102 is administered by two or more entities.

The information management system 102 can include one or more interfaces, i.e., interface(s) 108. The interface(s) 108 include functionality which allows external entities to interact with the information management system 102. Such external entities include the data sources 104, the data consumers 106, and one or more user devices 110 that are operated by users. The users may represent the individuals who are associated with the healthcare-related information maintained and distributed by the information management system 102. For instance, in a hospital setting, the users correspond to respective patients or former patients.

The information management system 102 further includes a data collection module 112. The data collection module 112 includes functionality for receiving healthcare-related information from the data sources 104 and storing the information in one or more data stores, referred to in the singular as data store 114. The information that is collected is referred to herein as collected information. The data collection module 112 can use any technique to collect healthcare-related information from the data sources 104, including a push technique (in which a data source independently forwards healthcare-related information to the information management system 102), a pull technique (in which the data collection module 112 actively requests the healthcare-related information from a data source), or any combination thereof. In the pull technique, the data collection module 112 can perform its polling on a periodic basis and/or in response to any triggering event or events.

The information management system 102 also includes a consent management module 116. The consent management module 116 includes functionality for receiving and storing consent information in one or more data stores, referred to in the singular as data store 118. For each user, the consent information describes one or more permission rules, which may be established by the user and/or some other source, which govern the dissemination of that user's collected information to particular data consumers 106. FIG. 2, to be described below, will provide additional details on one manner of expressing the consent information. In one case, the consent information is stored at the same site as the collected information; in another case, the consent information is stored at a different site than the collected information.

The information management system 102 also includes an information distribution module 120. The information distribution module 120 distributes parts of the collected information (maintained in the data store 114) to the data consumers 106, as governed by the consent information (maintained in the data store 118).

Consider the operation of the information distribution module 120 for the case of a representative user. When a triggering event is received, the information distribution module 120 consults the consent information for that user to determine whether one or more data consumers 106 are entitled to receive a part of the user's collected information. In one case, the triggering event may correspond to an express request by one of the data consumers 106 to receive part of the collected information. In that case, the information distribution module 120 can consult the consent information for the user to determine whether it is appropriate to honor the request of the data consumer. In another case, the triggering event may correspond to an express instruction by a user to provide part of the collected information to one or more data consumers.

In another case, the triggering event may correspond to an independent decision by the information management system 102 to forward part of the collected information to one or more data consumers. For example, in one scenario, the user may have established a permission rule, as part of the consent information, which instructs the information management system 102 to automatically forward part of the collected information to the data consumer(s) upon the occurrence of certain triggering events. One such triggering event may correspond to receipt of a new item of collected information in the data store 114. In another case, a user may establish a permission rule which instructs the information distribution module 120 to determine, on a periodic basis or otherwise, whether there is any new collected information in the data store 114; if so, the permission rule can instruct the information distribution module 120 to forward that information to the data consumer(s).

Generally, the types of triggering events described above are representative, not exhaustive; that is, other implementations can incorporate the use of other types of triggering events. In any case, the information distribution module 120 can perform the above-described decision process on an ongoing basis with respect to the accounts of all users.

The information distribution module 120 can employ various mechanisms to demonstrate the authenticity of the collected information that it sends to the data consumers 106. For example, the information distribution module 120 can append a signature-bearing certificate to each message that it sends to a data consumer. That certificate, signed by a trusted authority, provides some measure of assurance to the data consumer that the received information originates from the information management system 102, and not some malicious entity which is masquerading as the information management system 102.

The information management system 102 can also include an administration module 122. Among other tasks, the administration module 122 can maintain user information regarding users who have accounts with the information management system 102. The administration module 122 can store this user information in one or more data stores, referred to in the singular below as data store 124. The user information can include user identifiers associated with the accounts. Further information regarding the user identifiers will be set forth below in the context of FIG. 3. The user information can also include profile information regarding the users. In a healthcare-related context, the profile information may describe, among other information, the medical conditions associated with the users, etc.

In one implementation, the components of the information management system 102 shown in FIG. 1 comprise a centralized platform for delivering services to data consumers using a client-server mode of operation. In this implementation, all (or most) of the services and collected information provided by the information management system 102 are implemented by the centralized platform. But this paradigm can be varied in any number of ways. For example, in another implementation, upon instruction, a provisioning module 126 can send code and/or collected information to at least one data consumer. This allows the recipient data consumer to provide a local instance of one or more services provided by the remote information management system 102 and/or any collected information provided by the remote information management system 102. For example, FIG. 1 shows a representative data consumer 128 which provides one or more local services 130 and/or a data store 132 that provides a local instance of collected information.

To cite one example, the data consumer 128 may correspond to a computer system of a hospital which serves a population of patients. The provisioning module 126 can transfer a sub-corpus of the collected information maintained in the data store 114 to the data consumer 128 that pertains to the patients. The provisioning module 126 can also transfer code that implements a subset of services to the data consumer 128. Those services allow healthcare professionals at the hospital to access the sub-corpus of collected information without accessing the remote instance of the information management system 102. For example, the local services can implement any aspect of the interfaces 108, the information distribution module 120, the consent management module 116, the administration module 122, and so on. For example, a local instance of the information distribution module 120 can receive a request for patient data by a local healthcare professional. A local instance of the consent management module 116 can then determine whether the healthcare professional is entitled to receive the patient data. If so, the local instance of the information distribution module 120 can allow the healthcare professional to access the patient data. The remote instance of the information management system 102 can periodically send updated collected information to the local instance of the information management system 102 so that the local instance of this information remains current.

To facilitate and simplify explanation, it will henceforth be assumed that the services and collected information provided by the information management system 102 are provided at a centralized platform. However, any operations that can be performed by the centralized platform can alternatively, or in addition, be performed by a local instance of the information management system 102. The general term “information management system” 102 encompasses any instance(s) of the functionality described herein, whether implemented at a remote centralized platform, a localized instance, or both.

In addition, the functions performed by the consent management module 116 can be performed in different ways. In one case, the consent management module 116 comprises a centralized platform which determines whether a data consumer is entitled to receive the information that it has requested. In this scenario, a data consumer which makes a request is expected to provide sufficient information which identifies it to the consent management module 116.

In another case, the consent management module 116 can implement its functions using a claims-based authentication paradigm. In this approach, when the data consumer makes a request, a verifier module (not shown) can evaluate whether the data consumer is entitled to receive the requested information. For example, the verifier module can receive identifying information from the data consumer to determine whether the data consumer is who they claim to be; in addition, the verifier module can consult the rules in the consent information to determine whether the data consumer is entitled to receive the collected information that it has requested. If the data consumer passes these tests, the verifier module can issue a security token to the data consumer which indicates that the data consumer is entitled to receive the requested information. A separate consent management application module (not shown) can then authorize the data consumer to access the requested information on the basis of the security token.

One potential advantage of the claims-based approach is that it can reduce the amount of private information that a data consumer is expected to provide to the consent management application module. This is because another entity, the verifier module, performs the verification. The security token provided to the consent management application module indicates whether the data consumer is entitled to receive the requested information, without otherwise revealing additional information regarding the data consumer. This approach also provides flexibility in the verification of requests by data consumers. For instance, a consent management application module can potentially outsource verification tasks to plural verifier modules that provide security tokens using different respective authentication paradigms.

In another implementation, the verifier module can also issue security tokens that confer rights to particular types of entities. This may be referred to as entity-based authentication. In this approach, for instance, the verifier module can issue a security token to a data consumer which indicates that the data consumer is a particular type of entity, such as a researcher, or a surgeon within a hospital, etc. The consent management application module can then grant the data consumer certain rights based that are commensurate with the information specified in the security token.

To facilitate and simplify explanation, it will henceforth be assumed that the consent management module 116 is implemented by a unified platform that performs all security checking. However, any operations that can be performed by the unified platform can alternatively, or in addition, be performed by in the above-described distributed claims-based manner (e.g., using one or more verifier modules in conjunction with a consent management application module), or in any other manner. In other words, reference to the general term “consent management module” 116 is considered to encompass at least the implementations described above, including the distributed claims-based implementation.

Advancing to FIG. 2, this figure shows a sample of the consent information which is maintained in the data store 118. For each user, the consent information describes the permission rules, established by the user, which set forth the conditions under which data consumers 106 are entitled to access the user's collected information. Each permission rule may have one or more components. Representative permission components are described below.

(a) What can be accessed? A permission rule can describe the nature of the collected information that the data consumer(s) are entitled to access. For example, a permission rule can describe the general type of collected information that the data consumer(s) are authorized to access. For instance, such a permission rule can specify that the data consumer(s) are permitted to access all lab records, or all lab records pertaining to diabetes tests, and so on. Other implementations can use any criterion or criteria to specify the subject matter to which the data consumer(s) are entitled, such as by specifying keywords that pertain to the subject matter, etc.

(b) From where can it be accessed? In addition, or alternatively, a permission rule can describe one or more data sources from which the data consumer(s) are entitled to access collected information. For instance, such a permission rule can specify that the data consumer(s) are entitled to access all lab results received from lab XYZ.

(c) Who can access it? A permission rule can describe the particular data consumer(s) who are entitled to access the collected information. This permission component can be expressed in any level of specificity based on any filtering factor or factors. For instance, a broad permission rule may specify that all data consumers that have been previously registered by the user are entitled to receive the user's collected information or some part thereof. Another permission rule can more selectively identify certain data consumers who are entitled to access some parts of the collected information, but not other parts. These data consumers can be identified by general class (e.g., by identifying all doctors associated with hospital XYZ), or individually (e.g., by identifying individual doctors).

As a preliminary to writing such permission rules, in one implementation, each user may specify a group of data consumers that are entitled to access at least some of the collected information. The user can provide any identifying information for this purpose, such as the addresses of the data consumers 106 (e.g., the IP addresses), etc. In addition, the registration process can involve exchanging appropriate keys between the information management system 102 and the data consumers 106. The keys enable the information management system 102 and the data consumers 106 to exchange data in encrypted form.

(d) When can it be accessed? A permission rule can describe when the data consumer(s) are entitled to access the collected information. In other words, this type of permission rule specifies the triggering event which prompts the information distribution module 120 to send the collected information to the data consumer(s), or otherwise makes the collected information available to the data consumer(s). For example, one permission rule can instruct the information distribution module 120 to send at least part of the collected information to the data consumer(s) when it is newly added to the data store 114. Another permission rule can instruct the information distribution module 120 to send the collected information to the data consumer(s) when they expressly request that information, and so on.

(e) What kinds of searches are authorized? As will be described below in the context of FIG. 4, the information management system 102 can include searching functionality (not shown in FIG. 1) which allows inquiring entities to perform searches within user-related information. Based on the search results generated by this search, the search functionality can then optionally send messages to one or more target users. A permission rule established by a user can indicate whether this mode of operation is enabled or disabled, e.g., in wholesale fashion or with respect to particular inquiring entities. For example, a permission rule can indicate that specific researchers (or types of researchers) are permitted (or not permitted) to access information regarding the user for research-related purposes. Alternatively, or in addition, a permission rule can indicate that specific providers of services (or types of providers) are permitted (or not permitted) to access the user's information and to send messages to the user. Alternatively, or in addition, a permission rule can indicate whether other users (or types of users) are permitted (or not permitted) to access the user's information and to send messages to the user, and so on.

The above-described types of permission rules and components are illustrative, not exhaustive; other implementations can adopt the use of other types of permission rules and components. For example, another implementation can accommodate a permission rule which places restrictions on the data sources 104 which are permitted to forward information to the information management system 102. In the implementation described above, by contrast, the information management system 102 can receive information in unrestricted fashion from any registered entity (and/or, potentially, any unregistered entity) that is able to add information to a user's account.

The consent management module 116 can solicit the consent information from a user in different ways. In one case, the consent management module 116 can provide a structured user interface presentation by which the user can express the various permission components described above. Alternatively, or in addition, the consent management module 116 can permit the user to enter permission rules in a more freeform manner. The consent management module 116 can then parse the permission rules to extract the permission components described above.

In the example of FIG. 2, user A has specified five permission rules (expressed in conversational text to promote understanding here). The first rule specifies that data consumer A can access all lab information. The second rule specifies that any data consumer can access all imaging information from data source M. A third rule specifies that data consumer B can access all lab information that was received after Jan. 1, 2011. A fourth rule specifies that data consumer C can access all information provided by doctor N. A fifth rule specifies that any provider can send this user any message, e.g., in response to performing a search to locate that user. User B specifies another set of permission rules, which are self-explanatory based on the descriptions provided in FIG. 2.

From a higher level standpoint, the consent information constitutes metadata that is associated with the collected information in the data store 114. The metadata is considered global metadata because it transcends and is agnostic to the particulars of any data source and any data consuming environment. For example, a rule, established by a user, may indicate that any dermatologist can access the user's medical records. This permission rule applies regardless of the system that any individual dermatologist uses to receive the medical records. And this permission rule is defined in the context of the platform provided by the information management system 102, not the functionality provided by originating data sources or downstream consumers.

While this description is framed primarily in the representative context of a healthcare-related domain, as said above, the information management system 102 can be applied to any data collection and dissemination environment. More generally stated, the information management system 102 can be used to collect information from diverse sources connected to a wide area network, such as the Internet. The information management system 102 uses the global consent metadata to control the manner in which data consumers of any type are permitted to access this information, rather than allowing data sources and data consumers to dictate the permissions in a separate and fractured manner. This aspect of the information management system 102 makes it easier for users to control the flow of personal information across diverse systems and platforms. It is also potentially more robust than a fractured approach, as the user is less apt to make errors in generating permission rules when that task is consolidated and generalized in the manner described.

Advancing to FIG. 3, this figure shows one manner of identifying users of the information system 102. In this approach, the administration module 122 assigns each user account a master identifier. For each user, the master identifier may be associated with one or more subordinate identifiers that also identify the user. For example, each data consumer, such as a hospital or doctor's office, may identify the user using a local identifier that is native to the platform used by that data consumer. Such a local identifier may comprise one of the subordinate identifiers that are associated with the master identifier. In some cases, a particular entity may also use plural subordinate identifiers to refer to a particular user. For example, a clinic having multiple departments may use multiple subordinate identifiers to refer to the user, each subordinate identifier corresponding to a different department.

As will be set forth more fully in Section B, in one case, the message that the information distribution module 120 sends to a particular data consumer can specify the master identifier of a particular user, or at least one subordinate identifier, or a combination of the master identifier and at least one subordinate identifier. If only the master identifier is provided, the recipient data consumer can translate the master identifier to its own local subordinate identifier for the user (if it, in fact, uses such a local identifier). A data consumer can request a user's collected information from the information management system 102 by specifying the master identifier, or at least one subordinate identifier, or a combination of at least one subordinate identifier and the master identifier.

In a similar fashion, the data collection module 112 can receive information that is accompanied by a master identifier, or at least one subordinate identifier, or a combination of at least one subordinate identifier and the master identifier. In the case in which only a subordinate identifier is provided, the data collection module 112 can translate any local subordinate identifier to its corresponding master identifier so that the data collection module 112 can store the received information in the appropriate account.

A particular data consumer (or data source) may wish to use a subordinate identifier, either alone or in combination with a master identifier, for auditing purposes (as well as other possible purposes). For example, in the above-described multi-department clinic, the use of the subordinate identifiers allows the data consumer to maintain appropriate records regarding the requests that originate from different departments.

In one case, the administration module 122 can assign a new master identifier to each user. In another case, the administration module 122 can allow a user to choose his or her own master identifier. In this situation, a user can opt to use a pre-existing identifier that has already been assigned by another system, such as a social networking service. In this manner, the user can use the same master identifier to interact with two or more services, including the information management system 102.

FIG. 4 shows searching functionality 402 that can be used by any inquiring entity to search user-related information. The searching functionality 402 comprises another functional module in the information management system 102 of FIG. 1, although not shown in that figure. As used herein, the term user-related information refers to any component of information maintained by the information management system 102. The user-related information can include any of the user information (including user profile information) maintained in the data store 124, the collected information maintained in the data store 114, and the consent information maintained in the data store 118. After finding one or more target users that meet prescribed search conditions, the inquiring entity can then optionally send a message to the target users.

The searching functionality 402 includes an interface module 404 for interacting with one or more inquiring entities. For example, an inquiring entity can correspond to a researcher which seeks access to user-related information for a research-related purpose. In another case, an inquiring entity can correspond to a provider. The provider may correspond to an individual or organization or some other entity that wishes to provide a message to one or more target users with the intent of providing any kind of service to the target users. For example, a company that provides diabetes management products may wish to sell such products to users who have diabetes. In another case, a drug manufacturer or government agency may wish to provide an alert to those users to who take a certain medication, and so on. In another case, an inquiring entity can correspond to another user who maintains an account with the information management system 102. For example, another user may wish to find other users who share the same condition, with the possible intent of establishing a conversation regarding the condition. Still other types of inquiring entities can interact with the searching functionality 402.

As a first step, the interface module 404 receives a search request from an inquiring entity. The search request can include a search condition (e.g., one or more search terms), specified in any manner. These search conditions are chosen to target particular users. For example, a provider who wishes to identify patients that suffer from high blood pressure might specify the search term “high blood pressure.” The interface module 404 forwards the search request to a search module 406. In another case, the provider may specify “Connecticut” to identify patients in that state, and so on.

The search module 406 includes functionality for searching through any user-related information to identify users who match the search condition. In the case specified above, the search module 406 can identify users that suffer from high blood pressure. Such a fact can be expressed, for instance, in the collected information pertaining to the users (e.g., in the medical records of those users) and/or in the user profile information of those users, etc. The search module 406 can use any search functionality for performing this search, such as by using an index that identifies the correlation between search terms and users. The outcome of the searching process is referred to herein as original search results. In one implementation, the search module 406 forwards the original search results to an obfuscation module 408.

The obfuscation module 408 removes or otherwise obscures sensitive information within the search results. The obfuscation process makes it impossible or unlikely that a recipient can discover the sensitive information. One field of the sensitive information that is obfuscated is any information that expresses the identities of the users identified in the original search results. In one case, the obfuscation module 408 can obfuscate the sensitive information by replacing it with random or seemingly random information, e.g., by taking a hash of the sensitive information to produce random-looking information. As a result of its processing, the obfuscation module 408 produces obfuscated search results. The obfuscated search results identify one or more candidate users, but in concealed form.

In one implementation, the interface module 404 sends the obfuscated search results to the inquiring entity. The inquiring entity can examine the obfuscated search results and then optionally decide to send a message to any one or more target users selected from among the candidate users. For example, demographic information in the obfuscated search results may reveal that a subset of the users who suffer from high blood pressure are located in the Northeast part of the United States. If a provider is interested in sending a promotional offer to these users, the provider can select these users as the target users. The inquiring entity can then send a request to the interface module 404, which instructs the searching functionality 402 to send a message to the target user(s). The inquiring entity can also specify the message to be sent.

Finally, a user contact module 410 performs the task of forwarding a message to the target users. If the target users do not wish to receive such messages in the future, they can change appropriate preference rules in their consent information. The user contact module 410 can send messages to the target users in any manner, such as by posting messages to the accounts of the users (which they can access when logged onto the information management system 102), by sending Email messages to the target users, by sending instant messages to the target users, etc.

In another manner of operation, the inquiring entity can instruct the searching functionality 402 to send a message to any target user who meets the search request, without first receiving obfuscated search results. For example, a provider can instruct the searching functionality 402 to send a message to all users who have high blood pressure, without being given the opportunity to examine and select from the list of candidate users that meet this criterion.

In contrast, a researcher can receive the obfuscated search results and perform analysis on the obfuscated search results. The researcher will typically forego the step of contacting the users who are associated with the obfuscated search results.

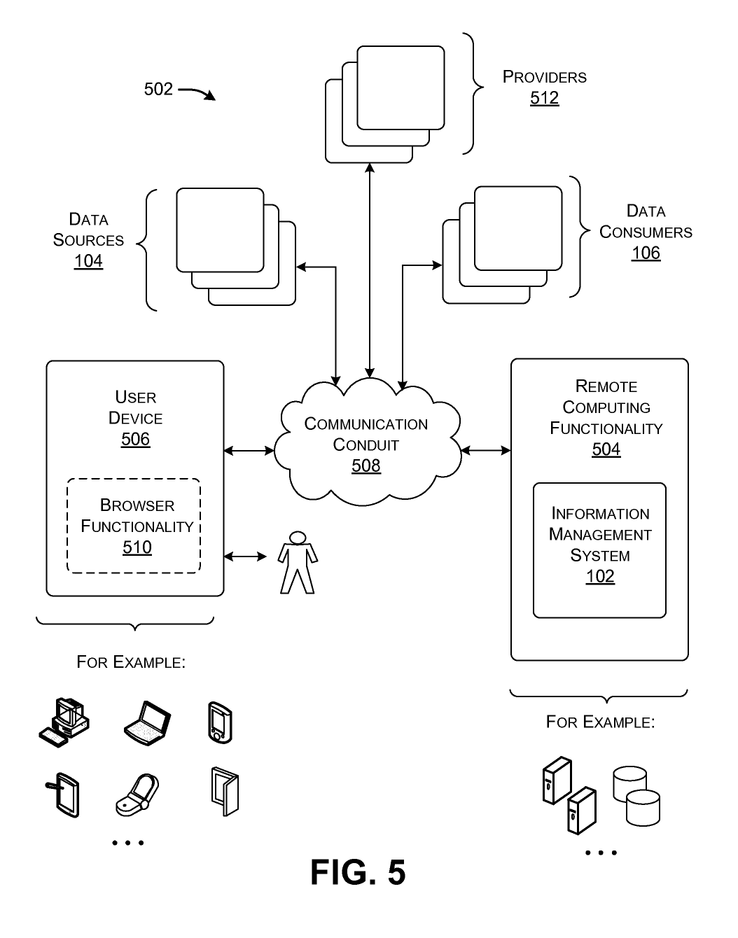

Advancing to FIG. 5, this figure shows one physical implementation 502 of the information management system 102 of FIG. 1. In this implementation 502, remote computing functionality 504 hosts the information management system 102. The remote computing functionality 504 can be implemented by equipment located at a single site or equipment that is distributed over plural sites. That equipment can comprise, for instance, one or more computer servers, data stores, routers, and/or other processing equipment.

A user can operate a user device 506 to interact with the remote computing functionality 504 via a communication conduit 508. The user device 506 can comprise any type of computing device, such as a personal computer, a computer workstation, a laptop computer, a game console device, a set-top box device, a personal digital assistant, a mobile telephone device, an electronic book reader device, and so on. In one case, the user can interact with the remote computing functionality 504 using browsing functionality 510 which is installed on the user device 506.

The communication conduit 508 can comprise any type of coupling mechanism, including a local area network, a wide area network (e.g., the Internet), a point-to-point connection, and so on. The communication conduit 508 can be physically implemented using any combination of hardwired links, wireless links, routers, gateways, name servers, etc., as governed by any protocol or combination of protocols.

Other entities can also communicate with the remote computing functionality 504 via the communication conduit 508, including the data sources 104, the data consumers 106, and service providers 512. Each of these entities can be implemented by any type of computing functionality, such as any type of computing functionality described above with respect to the remote computing functionality 504 and/or the user device 506. As described above, any data consumer can optionally implement a local instance of any sub-corpus of collected information and/or services provided by the remote information management system 102.

B. Illustrative Processes

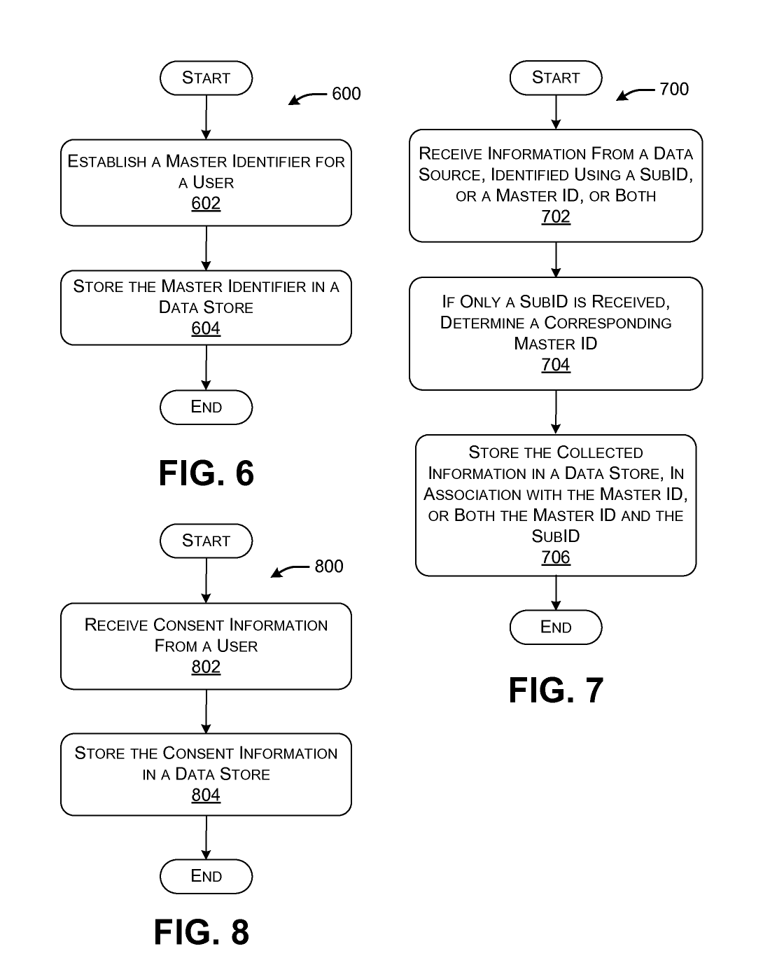

FIGS. 6-12 show procedures which explain the operation of the information management system 102 of FIG. 1 in flowchart form. Since the principles underlying the operation of the information management system 102 have already been described in Section A, certain operations will be addressed in summary fashion in this section.

Starting with FIG. 6, this figure shows a procedure 600 for establishing a master identifier for a user. In block 602, a user may interact with the administration module 122 of the information management system 102 to establish the master identifier. As described in Section A, the administration module 122 can either assign a new master identifier to the user or, upon instruction from the user, use a pre-existing master identifier specified by the user. The master identifier may be associated with one or more subordinate identifiers, which the user may also specify. In block 604, the administration module 122 can store the master identifier (and any subordinate identifiers) in the data store 124.

FIG. 7 shows a procedure 700 for collecting information from a data source. In block 702, the data collection module 112 receives information from the data source, e.g., using a push technique, a pull technique, or some combination thereof. The information may be identified using at least one subordinate identifier (“sublD”), or a master identifier (“master ID”), or a combination of at least one subordinate identifier and the master identifier.

Assume that the information that is provided specifies only a subordinate identifier. If so, in block 704, the data collection module 112 can access the user information in store 124, using the administration module 122, to thereby determine a master identifier that corresponds to the provided subordinate identifier.

In block 706, the data collection module 112 stores the collected information in the data store 114. The data collection module 112 can store the collected information in association with the master identifier, or at least one subordinate identifier, or a combination of the master identifier and at least one subordinate identifier.

FIG. 8 shows a procedure 800 for collecting consent information from a user, e.g., after the user logs into the information management system 102 using a master identifier or some other identifier. In block 802, the consent management module 116 receives consent information from the user, which may comprise one or more permission rules. Each permission rule, in turn, may be composed of one or more permission components described in Section A. In block 804, the consent management module 116 stores the consent information in the data store 118.

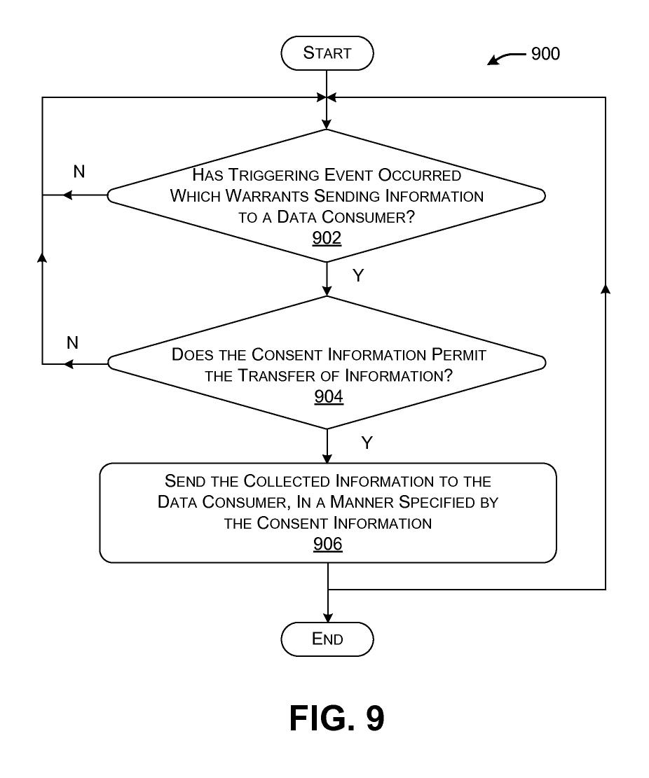

FIG. 9 shows a procedure 900 which explains one manner of operation of the information distribution module 120. In block 902, the information distribution module 120 determines whether a triggering event has occurred which prompts the sending of collected information to at least one data consumer. As described in Section A, a triggering event may correspond to a request by the data consumer, an instruction from a user, an independent decision to forward the collected information by the information management system 102, and so on. In block 904, the information distribution module 120 consults the consent information for the user to determine whether it is appropriate to send the collected information to the data consumer. In some cases, blocks 902 and 904 comprise an integral inquiry, insofar as the triggering circumstance that prompts the sending of information may comprise timing information or the like that is expressed by the consent information. In block 906, if blocks 902 and 904 are answered in the affirmative, then the information distribution module 120 sends the collected information to the data consumer. The collected information may correspond to any part of an entire corpus of collected information that pertains to the user. The information distribution module 120 can encrypt the collected information and attach a certificate to it so that the recipient data consumer(s) can verify the authenticity of the collected information. In the manner described more fully below, the information distribution module 120 can identify the collected information that it sends to the data consumer using a master identifier, or a subordinate identifier, or a combination of the master identifier and the subordinate identifier.

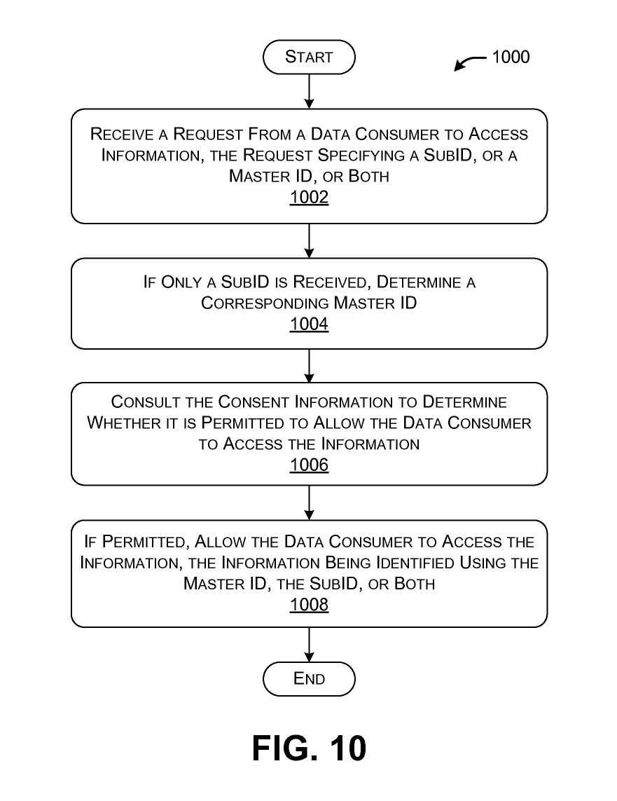

FIG. 10 is a procedure 1000 that shows one instantiation of the procedure 900 of FIG. 9, for the case in which a data consumer expressly requests collected information from the information management system 102. In block 1002, the information distribution module 120 receives a request from the data consumer. That request may specify a master identifier, or at least one subordinate identifier, or a combination of the master identifier and at least one subordinate identifier.

Assume that the request that is received specifies only a subordinate identifier. If so, in block 1004, the information distribution module 120 can access the user information in store 124, using the administration module 122, to thereby determine a master identifier that corresponds to the provided subordinate identifier.

In block 1006, the information distribution module 120 consults the consent information for the user to determine whether it is appropriate to send the collected information to the data consumer, e.g., by using the master identifier as at least part of a key to identify the appropriate consent information. If so, in block 1008, the information distribution module 120 accesses the collected information (again using the master identifier as at least part of a key) and sends the collected information to the data consumer. As explained above, the information distribution module 120 can identify the collected information that it sends to the data consumer using a master identifier, or a subordinate identifier, or a combination of the master identifier and the subordinate identifier.

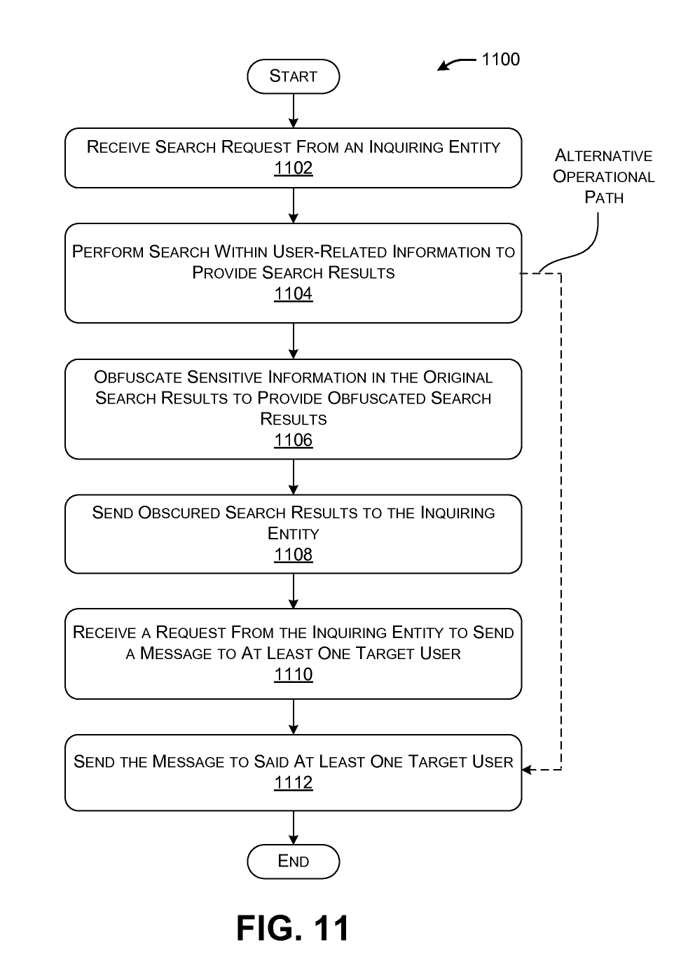

FIG. 11 is a procedure 1100 that shows one manner of operation of the searching functionality 402 of FIG. 4. In block 1102, the searching functionality 402 receives a search request by an inquiring entity (e.g., a researcher, a provider, another user, etc.). In block 1104, the searching functionality 402 performs a search within user-related information based on the search request, to generate original search results. The original search results identify one or more candidate users. In block 1106, the searching functionality 402 optionally obfuscates the original search results to remove sensitive information (such as the users' identifiers) from the original search results. This produces obfuscated search results. In block 1108, the searching functionality 402 sends the obfuscated search results to the inquiring entity.

In block 1110, the searching functionality 402 optionally receives a request from the inquiring entity to send a message to one or more target users. The inquiring entity can select the target user(s) from the candidate users identified in the obfuscated search results. In block 1112, the searching functionality 402 can send a message to the target user(s). The dashed line in FIG. 11 indicates that, in another mode, the searching functionality 402 can immediately send a message to the users identified in the original search results, e.g., without first inviting the inquiring entity to select from among the candidate users.

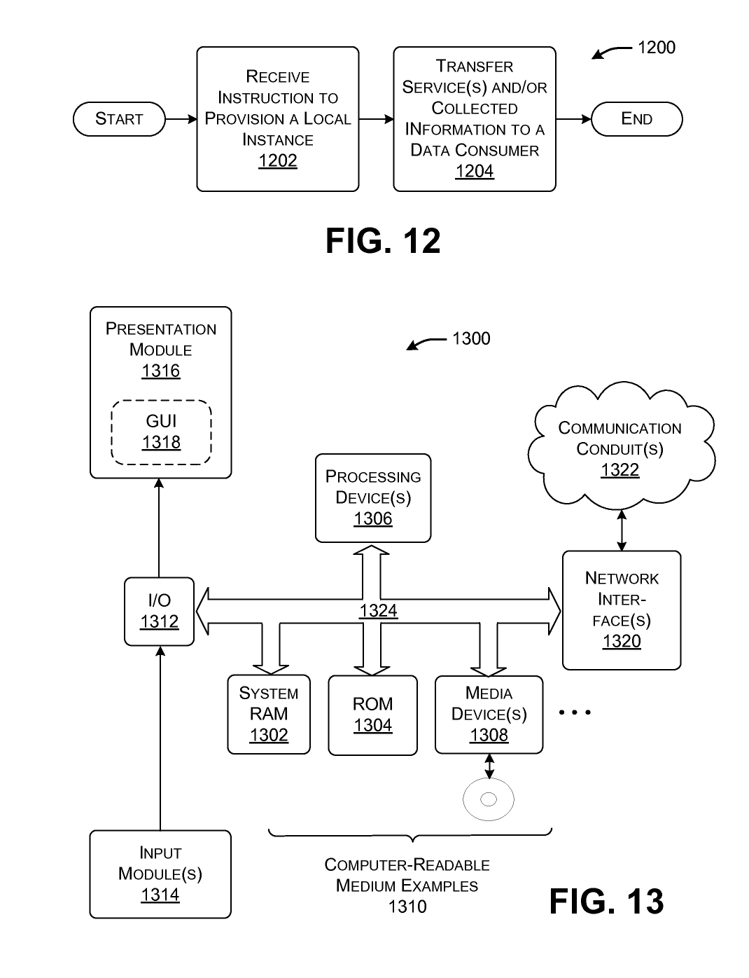

FIG. 12 shows a procedure 1200, performed by the provisioning module 126, for providing a local instance of at least part of the information management system 102 to a data consumer. In block 1202, the provisioning module 126 receives a request to provide the local instance. This request can originate from the data consumer and/or any other source. In block 1204, the provisioning module 126 transfers code associated with one or more services and/or a subset of collected information to the data consumer, where it constitutes a local instance of at least part of the information management system 102. Henceforth, the data consumer can access the functionality provided by the information management service 102 using either the remote instance or the local instance, or both. As such, any of the functions described in Section B can be performed by the remote instance or the local instance, or both.

As a general point, the information management system 102 can provide appropriate safeguards to maintain the privacy of the users' personal information. Such safeguards can include (but are not limited to) encrypting the collected information that is maintained in the data store 114, encrypting the messages that are sent to the data consumers 106, removing sensitive information from the search results provided to providers and other users, and so on. In addition, the users may create permission rules that expressly define what information is shared with external entities. In the extreme, any user may, for any reason, completely disable information sharing, so that the information distribution module 120 will not send any information to any data consumer.

C. Representative Processing Functionality

FIG. 13 sets forth illustrative electrical data processing functionality 1300 (also referred to herein a computing functionality) that can be used to implement any aspect of the functions described above. For example, the processing functionality 1300 can be used to implement any aspect of the information management system 102 of FIG. 1, e.g., as implemented in the embodiment of FIG. 5, or in some other embodiment. In one case, the processing functionality 1300 may correspond to any type of computing device that includes one or more processing devices. In all cases, the electrical data processing functionality 1300 represents one or more physical and tangible processing mechanisms.

The processing functionality 1300 can include volatile and non-volatile memory, such as RAM 1302 and ROM 1304, as well as one or more processing devices 1306 (e.g., one or more CPUs, and/or one or more GPUs, etc.). The processing functionality 1300 also optionally includes various media devices 1308, such as a hard disk module, an optical disk module, and so forth. The processing functionality 1300 can perform various operations identified above when the processing device(s) 1306 executes instructions that are maintained by memory (e.g., RAM 1302, ROM 1304, or elsewhere).

More generally, instructions and other information can be stored on any computer readable medium 1310, including, but not limited to, static memory storage devices, magnetic storage devices, optical storage devices, and so on. The term computer readable medium also encompasses plural storage devices. In all cases, the computer readable medium 1310 represents some form of physical and tangible entity.

The processing functionality 1300 also includes an input/output module 1312 for receiving various inputs (via input modules 1314), and for providing various outputs (via output modules). One particular output mechanism may include a presentation module 1316 and an associated graphical user interface (GUI) 1318. The processing functionality 1300 can also include one or more network interfaces 1320 for exchanging data with other devices via one or more communication conduits 1322. One or more communication buses 1324 communicatively couple the above-described components together.

The communication conduit(s) 1322 can be implemented in any manner, e.g., by a local area network, a wide area network (e.g., the Internet), etc., or any combination thereof. The communication conduit(s) 1322 can include any combination of hardwired links, wireless links, routers, gateway functionality, name servers, etc., governed by any protocol or combination of protocols.

In closing, the description may have described various concepts in the context of illustrative challenges or problems. This manner of explication does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by physical and tangible computing functionality, for distributing collected information to a data consumer, comprising:
establishing a master identifier associated with a user;
storing the master identifier;
collecting information that pertains to the user from at least one data source, to provide collected information;
storing the collected information in association with at least the master identifier;
receiving consent information from the user, the consent information serving as global metadata that provides at least one permission rule, established by the user, which enables the data consumer to access at least part of the collected information;
storing the consent information in association with at least the master identifier;
upon occurrence of a triggering event, using the consent information to determine whether the data consumer is entitled to receive said at least part of the collected information; and
if the data consumer is entitled to receive said at least part of the collected information, allowing the data consumer to access said at least part of the collected information.

2. The method of claim 1, wherein the collected information corresponds to healthcare-related information.

3. The method of claim 1, wherein the consent information defines a nature of collected information which the data consumer is entitled to access.

4. The method of claim 1, wherein consent information defines a data source from which the data consumer is entitled to access collected information.

5. The method of claim 1, wherein the consent information defines an identity of the data consumer that is entitled to access the collected information.

6. The method of claim 1, wherein the consent information defines whether one or more providers of respective services are permitted to send messages to the user.

7. The method of claim 1, wherein the consent information defines whether one or more other users are permitted to send messages to the user.

8. The method of claim 1, wherein the method is performed, at least in part, by an information management system, and wherein the master identifier pertains to an identifier already established by a service other than the information management system.

9. The method of claim 1, wherein the information that is collected from a data source is expressed by specifying a subordinate identifier, and wherein said collecting comprises determining the master identifier that is associated with the subordinate identifier.

10. The method of claim 1, wherein the triggering event corresponds to a request, by the data consumer, to access said at least part of the collected information.

11. The method of claim 10, wherein the request by the data consumer is expressed by specifying a subordinate identifier, and wherein the method further comprises determining the master identifier that corresponds to the subordinate identifier, and wherein the collected information that is made accessible to the data consumer is identified by one or more of the subordinate identifier and the master identifier.

12. The method of claim 1, wherein the triggering event is a decision to push said at least part of the collected information to the data consumer, independent of a request by the data consumer.

13. The method of claim 1, further comprising:
receiving a search request from an inquiring entity to locate one or more users who meet a specified search condition;
performing a search within user-related information in response to the search request, to provide original search results that identify at least one candidate user;
obfuscating sensitive information in the original search result that identifies said at least one candidate user, to provide obfuscated search results;
sending the obfuscated search results to the inquiring entity;
receiving a request from the inquiring entity to send a message to at least one target user selected from said at least one candidate user, without the inquiring entity learning the sensitive information that identifies said at least one target user; and
sending a message to said at least one target user.

14. The method of claim 1, further comprising:
receiving a search request from an inquiring entity to locate one or more users who meet a specified search condition;
performing a search within user-related information in response to the search request, to provide original search results that identify at least one target user; and
sending a message to said at least one target user, without revealing to the inquiring entity sensitive information that identifies said at least one target user.

15. An information management system, implemented by physical and tangible computing functionality, for distributing collected information to data consumers, comprising:
an administrative module configured to establish master identifiers associated with respective users;
a user information data store for storing the master identifiers;
a data collection module configured to collect information that pertains to the users from at least one data source, to provided collected information;
a collection information data store for storing the collected information in association with at least the respective master identifiers;
a consent management module configured to receive consent information from the users, the consent information serving as global metadata that provides permission rules, established by the users, which enable the data consumers to access at least parts of the collected information pertaining to the users;
a consent information data store for storing the consent information in association with at least the respective master identifiers; and
an information distribution module configured to distribute said at least parts of the collected information to the data consumers based on the consent information.

16. The information management system of claim 15, wherein the information management system is communicatively coupled to user devices, data sources, and data consumers via a wide area network.

17. The information management system of claim 15, further comprising searching functionality, comprising:
an interface module configured to receive a search request from an inquiring entity to locate one or more users who meet a specified search condition;
a search module configured to perform a search within user-related information in response to the search request, to provide original search results that identify at least one candidate user; and
an obfuscation module configured to obfuscate sensitive information in the original search result that identifies said at least one candidate user, to provide obfuscated search results,
wherein the interface module is further configured to send the obfuscated search results to the inquiring entity.

18. A physical and tangible computer readable medium for storing computer readable instructions, the computer readable instructions providing an information management system when executed by one or more processing devices, the computer readable instructions comprising:
logic configured to establish and store a master identifier associated with a user;
logic configured to collect and store information that pertains to the user from at least one data source, to provide collected information;
logic configured to receive and store consent information from the user, the consent information serving as global metadata that provides at least one permission rule, established by the user, which enables at least one data consumer to access at least part of the collected information;
logic configured to receive a request from a data consumer to access at least part of the collected information, the request by the data consumer being expressed by specifying at least one of the master identifier of the user and at least one subordinate identifier associated with the user;
logic configured to use the consent information to determine whether the data consumer is entitled to access said at least part of the collected information; and
logic configured to allow the data consumer to access said at least part of the collected information if the data consumer is determined to be entitled to access said at least part of the collected information,
the global metadata being agnostic to any functionality used by the data consumer to access said at least part of the collected information.

19. The computer readable medium of claim 18, wherein the consent information defines one or more of:
a nature of information which the data consumer is entitled to access;
a data source from which the data consumer is entitled to access the collected information;
an identity of the data consumer that is entitled to access the collected information;
a temporal condition pertaining to when the data consumer is permitted to access to the collected information;
an indication of whether one or more providers of respective services are permitted to send messages to the user; and
an indication of whether one or more other users are permitted to send messages to the user.

20. The computer readable medium of claim 18, further comprising:
logic configured to receive a search request from an inquiring entity to locate one or more users who meet a specified search condition;
logic configured to perform a search within user-related information in response to the search request, to provide original search results that identify at least one candidate user;
logic configured to obfuscate sensitive information in the original search results that identifies said at least one candidate user, to provide obfuscated search results;
logic configured to send the obfuscated search results to the inquiring entity;
logic configured to receive a request from the inquiring entity to send a message to at least one target user selected from among said at least one candidate user, without the inquiring entity learning the sensitive information that identifies said at least one target user; and
logic configured to send a message to said at least one target user.
